(19) United States
(12) Patent Application Publication
(10) Pub. No.: US 2025/0326955 A1
(43) Pub. Date: Oct. 23, 2025

(54) ARTICLE CONTAINING A WASHABLE ADHESIVE COMPOSITION

(71) Applicants: Dow Global Technologies LLC, Midland, MI (US); Rohm and Haas Company, Collegeville, PA (US)

(72) Inventors: Pavel Janko, Tarragona (ES); Asghar A. Peera, Royersford, PA (US); Michael A. Mallozzi, Hatfield, PA (US); Eduardo Barba Andreu, Tarragona (ES); Sarah R. Zolynski, Philadelphia, PA (US); Isabelle Uhl, Grasse (FR); Xinhong Wang, Shanghai (CN); Fang Liu, Shanghai (CN); David R. Keely, Louisville, KY (US); Li LI, Collegeville, PA (US)

(21) Appl. No.: 18/864,808

(22) PCT Filed: May 19, 2023
(86) PCT No.: PCT/CN2023/095343

§ 371 Date: Nov. 11, 2024

Related U.S. Application Data
(60) Provisional application No. 63/365,038, filed on May 20, 2022.
(60) Provisional application No. 63/365,041, filed on May 20, 2022.

(51) Int. Cl. C09J 7/38; B32B 7/12; B32B 27/06; B32B 27/10; B32B 43/00; C09J 5/00; C09J 11/06

(52) U.S. Cl. CPC C09J 7/385; B32B 7/12; B32B 27/06; B32B 27/10; B32B 43/006; C09J 5/00; C09J 11/06; B32B 2255/10; B32B 2255/12; B32B 2255/26; B32B 2307/514; B32B 2439/00; C09J 2203/334; C09J 2203/37; C09J 2301/408; C09J 2301/414; C09J 2301/502

(57) ABSTRACT

The present disclosure provides an article. In an embodiment, the article includes a first substrate and an adhesive layer in contact with the first substrate. The adhesive layer contains an adhesive composition. The adhesive composition includes (i) an acrylic polymer composed of polymerized units of (a) a first monomer that is a C₄-C₁₈ alkyl acrylate and (b) a second monomer selected from acrylic acid, methacrylic acid, and a C₁-C₃ alkyl acrylate optionally containing a hydroxyl group. The adhesive composition also includes (ii) at least one inorganic neutralizer, and (iii) at least one surfactant. The article includes a second substrate in contact with the adhesive layer.

CL BACKGROUND

Articles containing labels, such as labeled plastic containers, have created difficulty in recycling the article. The adhesive and/or the label facestock typically remains on the article during the recycling process which then requires additional energy and processing steps to make the plastic container clean from the adhesive and label contaminants.

The art recognizes the need for labeled plastic articles with improved recyclability. Specifically, a need exists for labeling the plastic articles with an adhesive layer that provides suitable adhesion performance; the adhesive layer simultaneously being readily separable from the plastic article—thereby enabling the plastic article to be recycled.

### SUMMARY

The present disclosure provides an article. In an embodiment, the article includes a first substrate and an adhesive layer in contact with the first substrate. The adhesive layer contains an adhesive composition. The adhesive composition includes (i) an acrylic polymer composed of polymerized units of (a) a first monomer that is a C₄-C₁₈ alkyl acrylate and (b) a second monomer selected from acrylic acid, methacrylic acid, and a C₁-C₃ alkyl acrylate optionally containing a hydroxyl group. The adhesive composition also includes (ii) at least one inorganic neutralizer, and (iii) at least one surfactant. The article includes a second substrate in contact with the adhesive layer.

### Definitions

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure).

The numerical ranges disclosed herein include all values from, and including, the lower and upper value. For ranges containing explicit values (e.g., from 1 or 2, or 3 to 5, or 6, or 7), any subrange between any two explicit values is included (e.g., the range 1-7 above includes subranges of from 1 to 2; from 2 to 6; from 5 to 7; from 3 to 7; from 5 to 6; etc.).

Unless stated to the contrary, implicit from the context, or customary in the art, all parts and percents are based on weight and all test methods are current as of the filing date of this disclosure.

An “acrylic polymer” is a polymer that contains polymerized acrylic monomer and, optionally, may contain at least one comonomer. An “acrylic monomer,” as used herein, is a monomer with the Structure (I) below:

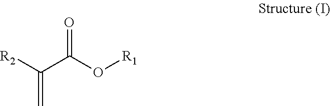

wherein R¹ is a H or a C₁-C₁₈ alkoxy group and R₂ is H or CH₃. Non-limiting examples of acrylic monomers include acrylic acid, methacrylic acid, acrylates, and methacrylates.

The term “alkyl” is a univalent hydrocarbon. A “hydrocarbon” is a compound composed of only hydrogen atoms and carbon atoms and containing straight chains and/or branched chains.

The terms “amine” and “amino” refer to both unsubstituted amine (e.g. NH₃ and NH₄+) and substituted amines (e.g., mono-substituted amines or di-substituted amines), wherein substituents may include, for example, alkyl, cycloalkyl, heterocyclyl, alkenyl, and aryl.

The terms “blend” or “polymer blend,” as used, refers to a mixture of two or more polymers. A blend may or may not be miscible (not phase separated at molecular level). A blend may or may not be phase separated. A blend may or may not contain one or more domain configurations, as determined from transmission electron spectroscopy, light scattering, x-ray scattering, and other methods known in the art. The blend may be effected by physically mixing the two or more polymers on the macro level (for example, melt blending resins or compounding), or the micro level (for example, simultaneous forming within the same reactor).

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

An “ethylene-based polymer” or “ethylene polymer” is a polymer that contains a majority amount of polymerized ethylene based on the weight of the polymer and, optionally, may comprise at least one comonomer. Ethylene-based polymers typically comprise at least 50 mole percent (mol %) units derived from ethylene (based on the total amount of polymerizable monomers).

An “olefin-based polymer” is a polymer that contains a majority mole percent polymerized olefin monomer (based on total amount of polymerizable monomers), and optionally, may contain at least one comonomer. Nonlimiting examples of olefin-based polymers include ethylene-based polymer and propylene-based polymer.

The term “polymer” or a “polymeric material,” as used herein, refers to a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

A “propylene-based polymer” is a polymer that contains a majority amount of polymerized propylene based on the weight of the polymer and, optionally, may comprise at least one comonomer. Propylene-based polymers typically comprise at least 50 mole percent (mol %) units derived from propylene (based on the total amount of polymerizable monomers). The terms “propylene-based polymer” and “polypropylene” may be used interchangeably.

### Test Methods

Adhesion. Samples are typically tested according the FINAT method no. 2 characterizing the adhesive peel strength at 90° peel angel from stainless steel (“SS”), Glass or high density polyethylene (“HDPE”) plates after 20 minutes and 24 hours dwell time. All measurements are typically performed in climatized room temperature 23° C.±2° C. and 50% RH±5% RH. The FINAT (Federation Internationale des fabricants et transformateurs d′ Adhésifs et Thermocollants) organization is the European association for the self-adhesive label industry (Laan van Nieuw-Oost Indië 131-G, 2593 BM The Hague, P.O. Box 85612, 2508 CH The Hague, The Netherlands).

Coating Weight. The adhesive coat weight is expressed as the weight of adhesive on a standard area of material—in grams per square meter (gsm or g/m²). In the product assembly, an adequate amount of s emulsion based adhesive (liquid stage) was coated on the pre-siliconized carrier (called liner) and dried for 2 min at 105° C. to remove the water from wet adhesive dispersion. This way the 18 gsm dry adhesive sample film was prepared and then laminated to the label facestock (film or paper).

Cohesion/Shear. To measure the cohesive strength of the adhesive the FINAT Test Method No. 8 is used where test sample of 1 inch×1 inch size is applied to the stainless steel panel according to the method described in FINAT test method no. 8 and then exposed to 1 kg hanging weight. The measurement is performed on the stainless steel plate but other substrates as glass can be considered. The measurement is performed in climatized room temperature 23° C.±2° C. and 50% RH±5% RH and the sample cohesion failure is recorded in “hours.”

Loop Tack. The standard FINAT method no. 9 was used to characterize the initial adhesion (adhesive tack) when the adhesive comes in contact with the substrate (glass, HDPE, SS). Testing was conducted after the adhesive coated laminate was conditioned in a controlled environment (23° C.±2° C. and 50% RH±5% RH relative humidity) for at least 4 hours. A strip 2.54 cm (1 inch) wide was cut and folded over to form a loop, exposing the adhesive side. It was then placed in between the jaws of the INSTRON™ tensile tester, and the lower jaw was lowered at a rate of 300 mm per minute to the substrate such that a square area of the adhesive of 2.54 cm by 2.54 cm (1 inch×1 inch) comes in contact with the substrate for 1 second. Then the adhesive was pulled away and the peak force to pull the adhesive away from the substrate was recorded.

### DETAILED DESCRIPTION

The present disclosure provides an article. In an embodiment, the article includes a first substrate and an adhesive layer in contact with the first substrate. The adhesive layer contains an adhesive composition. The adhesive composition includes (i) an acrylic polymer composed of polymerized units of (a) a first monomer that is a C₄-C₁₈ alkyl acrylate and (b) a second monomer selected from acrylic acid, methacrylic acid, and a C₁-C₃ alkyl acrylate optionally containing a hydroxyl group. The adhesive composition also includes (ii) at least one inorganic neutralizer, and (iii) at least one surfactant. The article includes a second substrate in contact with the adhesive layer.

The article includes a first substrate. The first substrate can be a container (bottle, can, pouch, ampule, jar, jug, box, bag, cup, vial, crate), a film, tubing, packaging, piping, clothing, foil. The first substrate can be composed of, or otherwise made from, metal (aluminum, copper, iron, gold, platinum, silver, steel, tin), wood (oak, pine, cedar, plywood, teak, mahogany, walnut, maple, beech, spruce, elm, rosewood, hickory, birch), glass (acrylic glass, borosilicate glass, lead glass), fabric (cotton, staple-fiber, polyester nonwoven, vinyl or nonwoven, silk, wool), foam (polyurethane foam, polyethylene foam), plastic (polyamide, polycarbonate, polyolefin, low density polyethylene, medium density polyethylene, high density polyethylene, linear low density polyethylene, polypropylene, polybutene, ethylene/α-olefin copolymer, polyolefin elastomer, r, polyethylene terephthalate, polybutylene terephthalate, polymethyl methacrylate, polyvinyl chloride, acrylonitrile-butadiene-styrene, polyester, polystyrene), paper material (cardboard) and any combination thereof.

The present article includes a second substrate. The second substrate can be composed of, or otherwise made from, plastic (polymethyl methacrylate, polyethylene, polypropylene, polyethylene terephthalate, polyvinyl chloride, acrylonitrile-butadiene-styrene, polycarbonate, polyester, polystyrene), cellulose-based material (paper, craft paper, crepe paper, Japanese paper, cardboard, siliconized paper, parchment paper), fluorocarbon polymer (polytetrafluoroethylene, polychlorotrifluoro-ethylene, polyvinyl fluoride, polyvinylidene fluoride, tetrafluoroethylene-hexafluoropropylene copolymer, chlorofluoromethylene-vinylidene fluoride copolymer), polyolefin (low density polyethylene, medium density polyethylene, high density polyethylene, linear low density polyethylene, polypropylene, polybutene, ethylene/α-olefin copolymer, polyolefin elastomer), fabric (nonwoven fabric, woven fabric), and any combinations thereof. In an embodiment, the second substrate is a facestock (interchangeably referred to as “label facestock”) composed of one or more of the foregoing materials.

In an embodiment, the second substrate is a label facestock. The label facestock can be paper, a synthetic paper (synthetic paper made from one or more plastics disclosed in the paragraph above). In a further embodiment, the label facestock is a synthetic paper with filler (calcium carbonate, titanium dioxide, clay etc.). One or both sides of the label facestock can be treated with a primer layer and/or surface modification treatment (corona treatment, radiation treatment) to improve adhesive anchorage, print anchorage, or its barrier properties

In an embodiment, the first substrate is a plastic container or a plastic film, and the second substrate is a label facestock. In a further embodiment, the first substrate is a plastic container and the second substrate is a paper label.

The article includes an adhesive layer containing with an adhesive composition containing an acrylic polymer composed of polymerized units of (a) a first acrylic-based monomer that is a C₄-C₁₈ alkyl acrylate and (b) a second acrylic-based monomer selected from acrylic acid, methacrylic acid, a C₁-C₃ alkyl acrylate optionally containing a hydroxyl group, and combinations thereof. Nonlimiting examples of suitable C₄-C₁₈ alkyl acrylate include butyl acrylate (BA), butyl methacrylate, 2-ethylhexyl acrylate (2-EHA), octyl acrylate, isooctyl methacrylate, decyl methacrylate, isodecyl methacrylate, lauryl methacrylate, pentadecyl methacrylate, and stearyl methacrylate.

Nonlimiting examples of suitable C₁-C₃ alkyl acrylate optionally containing a hydroxyl group include methyl acrylate, ethyl acrylate, propyl acrylate, hydroxyethyl acrylate, hydroxyethyl methacrylate, hydroxypropyl acrylate, and hydroxypropyl methacrylate.

In an embodiment, the acrylic polymer does not contain an olefinic monomer. Nonlimiting examples of olefinic monomers (which are excluded from the acrylic polymer) include ethylene, propylene, 1,3-butadiene, pentene, hexene, octene, styrene, and 5-ethylidene-2-norbornene.

In an embodiment, the acrylic polymer does not contain a vinyl chloride monomer.

In an embodiment, the acrylic polymer contains a third acrylic-based monomer that has a carboxylic acid functional group. Nonlimiting examples of the third monomer include acrylic acid, methacrylic acid, and itaconic acid. In an embodiment, the acrylic polymer is a 2-ethylhexyl acrylate/ethyl acrylate/acrylic acid terpolymer.

In an embodiment, the acrylic polymer contains, based on the total weight of the acrylic polymer, (i) from 50 wt % to 90 wt %, from 60 wt % to 80 wt %, from 65 wt % to 75 wt %, or from 50 wt % to 71 wt %, of the first monomer that is a C₄-C₁₈ alkyl acrylate, (ii) from 20 wt % to 50 wt %, from greater than 20 wt % to 40 wt %, or from 25 wt % to 40 wt % of the second monomer selected from acrylic acid, methacrylic acid, and a C₁-C₃ alkyl acrylate optionally containing a hydroxyl group, and optionally (iii) from 0.5 wt % to 20 wt %, from 1 wt % to 10 wt %, or from 1 wt % to 5 wt % of the third monomer that has a carboxylic acid functional group.

In addition to the acrylic polymer, the adhesive composition for the adhesive layer includes at least one an inorganic neutralizer. The term “neutralizer” refers to a basic substance that can react with an acidic material in an acid-base reaction. The term “inorganic neutralizer” refers to a neutralizer composed of a metal cation and a basic anion. Nonlimiting examples of a metal cation include a cation of an alkali metal (Group I of the periodic table) and an alkaline earth metal (Group II of the periodic table), such as Li⁺, Na⁺, K⁺, Cs⁺, Mg²⁺, and Ca²⁺. Nonlimiting examples of a basic anion include hydroxide (OH⁻). Nonlimiting examples of suitable inorganic neutralizers include sodium hydroxide, potassium hydroxide, lithium hydroxide.

In an embodiment, the at least one inorganic neutralizer is sodium hydroxide.

In an embodiment, the inorganic neutralizer excludes organic amine, or otherwise does not contain an amino group. In other words, the inorganic neutralizer excludes, or otherwise is void of, nitrogen atom (N).

The adhesive composition of the adhesive layer includes at least one surfactant. The surfactant can be a fatty alcohol ether sulfate. In an embodiment, the fatty alcohol ether sulfate includes a sodium salt of C₁₂-C₁₄ fatty alcohol ether sulfate. Commercially available examples of suitable surfactants include, but are not limited to, Disponil® FES 77 (containing ethoxylate sodium lauryl ether sulfate), FES 32 (containing sodium salt of fatty alcohol polyglycol ether sulfate), FES 993 (containing sodium salt of fatty alcohol polyglycol ether sulfate), and FES 61 (containing sodium salt of fatty alcohol polyglycol ether sulfate), each of which is available from BASF, and/or Abex 18S (containing sodium salt of an ethoxylated sulfated alcohol), available from Solvay.

In an embodiment, the adhesive composition contains other surfactants. Nonlimiting examples of suitable additional surfactants include sodium dioctyl sulfosuccinate and acetylenic diol ethylene oxide/propylene oxide adduct surfactants.

Commercially available sodium dioctyl sulfosuccinate surfactant includes Aerosol® OT-75. In an embodiment, the adhesive composition contains, based on the total weight of the adhesive composition, from 0.1 wt % to 3 wt %, or from 0.2 wt % to 1.5 wt %, or from 0.2 wt % to 1 wt % of sodium dioctyl sulfosuccinate surfactant.

Commercially available acetylenic diol ethylene oxide/propylene oxide adduct surfactants include, but are not limited to, SURFYNOL® 440, SURFYNOL® 104, SURFYNOL® 420, SURFYNOL®450, SURFYNOL® 465, and SURFYNOL® 485. The adhesive composition may contain, based on the total weight of the adhesive composition, 0 wt %, or from 0.05 wt % to 1.5 wt %, or from 0.1 wt % to 1 wt %, or from 0.1 wt % to 0.5 wt % of the acetylenic diol ethylene oxide/propylene oxide adduct surfactant. In an embodiment, the acetylenic diol ethylene oxide/propylene oxide adduct surfactant can be replaced or combined with a non-ionic branched secondary alcohol ethoxylate surfactant. Nonlimiting examples of suitable non-ionic branched secondary alcohol ethoxylate surfactants include TERGITOL™ TMN-10.

In an embodiment, the adhesive composition contains water.

In an embodiment, the adhesive composition optionally contains defoamers. Commercially available defoamers include, but are not limited to, Tego Antifoam 2291, Foamaster MO S090, Tego Antifoam KS 53, Tego Antifoam 2450, Tego Antifoam D 2315, BYK 011.

Other additives that can be added to the adhesive composition include one or more water soluble additives that can improve the wash off performance of the adhesive layer. Nonlimiting examples of water soluble additives include synthetic water soluble polymers such as polyethylene glycol (PEG), polyvinylpyrrolidone (PVP), poly(vinyl alcohol) (PVOH), polyacrylic acid (PAA), polyacrylamides, N-(2-hydroxypropyl) methacrylamide (HPMA), divinyl ether-maleic anhydride (DIVEMA), polyoxazoline, polyphosphates, polyphosphazenes, natural water soluble polymers such as xanthan gum, pectins, chitosan derivatives, dextran, carrageenan, guar gum, cellulose ethers, hyaluronic acid (ha), albumin, starch or starch based derivatives, or a combination thereof. Nonlimiting examples of water soluble additives include PEG 400, PEG 600, PEG1000, PEG1450, PEG3350, PEG8000, PVP K60, and PVP K90 with different molecular weights. In an embodiment, the adhesive composition contains, based on the total weight of the adhesive composition, 0 wt %, or from 0.05 wt % to 20 wt %, or from 0.25 wt % to 10 wt % of one or more additives.

Additionally, acid containing, cross-linked acrylic emulsion copolymers such as alkali-swellable acrylic emulsion (ASE) can be added to assist with the rheology and wash off performance of the polymer. Acceptable additives include, but are not limited to, ACRYSOL™ ASE-60. Additionally, rheology modifiers such as hydrophobically modified alkali swellable (HASE) associative thickener, can be added to assist with the rheology and wash off performance of the polymer. Acceptable additives include, but are not limited to, ACRYSOL™ RM-7, and ACRYSOL™ RM-55.

In an embodiment, the adhesive composition is void of, or substantially void of one, some, or all of the following: an olefinic monomer, a crosslinking component, a tackifier, adipic acid dihydrazide (ADH), a wax, a photo crosslinkable monomer, vinyl acetate, vinyl acetate derivatives, and any combinations thereof.

In an embodiment, the adhesive composition forms the adhesive layer and includes:
from 80 wt % to 99 wt %, or from 85 wt % to 99 wt %, or from 90 wt % to 99 wt %, or from 95 wt % to 99 wt %, based on the total weight of the adhesive composition, of the acrylic polymer;
from 0.05 wt % to 5 wt %, or from 0.5 wt % to 3 wt %, or from 0.5 wt % to 1 wt %, based on the total weight of the adhesive composition, of the at least one inorganic neutralizer;
from 0.1 wt % to 5 wt %, or from 0.5 wt % to 3 wt %, or from 1 wt % to 3 wt %, based on the total weight of the adhesive composition, of the at least one surfactant.

In an embodiment, the adhesive composition forms the adhesive layer and includes:
(1) from 80 wt % to 99 wt %, or from 85 wt % to 99 wt %, or from 90 wt % to 99 wt %, or from 95 wt % to 99 wt %, based on the total weight of the adhesive composition, of the acrylic polymer that is a 2-ethylhexyl acrylate/ethyl acrylate/acrylic acid terpolymer composed of
   (i) from 50 wt % to 90 wt %, from 60 wt % to 80 wt %, from 65 wt % to 75 wt %, or from 50 wt % to 71 wt %, based on the total weight of the terpolymer, of 2-ethylhexyl acrylate monomer;
   (ii) from 20 wt % to 50 wt %, from greater than 20 wt % to 40 wt %, or from 25 wt % to 40 wt %, based on the total weight of the terpolymer, of ethyl acrylate monomer; and
   (iii) from 0.5 wt % to 20 wt %, or from 1 wt % to 10 wt %, or from 1 wt % to 5 wt %, based on the total weight of the terpolymer, of acrylic acid monomer;
(2) from 0.05 wt % to 5 wt %, or from 0.5 wt % to 3 wt %, or from 0.5 wt % to 1 wt %, based on the total weight of the adhesive composition, of the at least one inorganic neutralizer that is sodium hydroxide; and
(3) from 0.1 wt % to 5 wt %, or from 0.5 wt % to 3 wt %, or from 1 wt % to 3 wt %, based on the total weight of the adhesive composition, of the at least one surfactant that is a sodium salt of C₁₂-C₁₄ fatty alcohol ether sulfate; and the adhesive composition is in direct contact with the first substrate and the second substrate (label facestock) at a coat weight from 0.1 gsm to 50 gsm, or from 5 gsm to 35 gsm, or from 10 gsm to 20 gsm.

In an embodiment, at least one surface of the second substrate (label facestock) to which the adhesive layer is applied is/are subjected to a surface treatment including a primer coating. The primer coating includes a hydrophilic or hydrophobic primer with Tg above ±10° C. Nonlimiting examples of primer include PRIMAL™ TR-407, PRIMAL™ P-376LO. The primer coating forms a primer layer that is in direct contact with the second substrate and adhesive layer at a coat weight 0.01 grams per square meter (gsm), or from 0.01 gsm to 5 gsm, from 0.05 gsm to 4 gsm, from 0.1 gsm to 3 gsm, or from 1 gsm to 2 gsm.

In an embodiment, the structure of the article is first substrate/present adhesive layer/primer coating/second substrate. Alternatively, the structure of the article can be
A) First substrate/present adhesive layer/(optional standard adhesive layer)/primer coating/second substrate.

Each of the adhesive layers coating weight is from 0.1 gsm to 50 gsm from 0.1 gsm to 50 gsm, or from 5 gsm to 35 gsm, or from 10 gsm to 20 gsm.

The present disclosure provides a process. The process includes providing a batch containing the article and a wash solution. The article includes a first substrate. The article also includes an adhesive layer in contact with the first substrate. The adhesive layer contains an adhesive composition. The adhesive composition includes (i) an acrylic polymer composed of polymerized units of (a) a first monomer that is a C₄-C₁₈ alkyl acrylate and (b) a second monomer selected from acrylic acid, methacrylic acid, and a C₁-C₃ alkyl acrylate optionally containing a hydroxyl group, (ii) at least one inorganic neutralizer, and (iii) at least one surfactant. The article includes a second substrate in contact with the adhesive layer. The wash solution of the batch includes water, a surfactant, and a base.

Nonlimiting examples of surfactants that can be included in the wash solution include TRITON X 100, Tergitol 15-S-9, Tergitol 15-S-15, and Tergitol 15-S-12. In an embodiment, the surfactant in the wash solution includes a non-ionic secondary alcohol ethoxylate surfactant. Nonlimiting examples of suitable non-ionic secondary alcohol ethoxylate surfactants include Tergitol 15-S-9.

In an embodiment, the wash solution contains 0 wt %, or from 0.05 wt % to 5 wt %, or from 0.1 wt % to 3 wt %, or from 0.5 wt % to 1.5 wt % of the surfactant, based on the total weight of the wash solution.

Nonlimiting examples of suitable base for the wash solution include NaOH and/or KOH. In an embodiment, the base in the wash solution is sodium hydroxide.

In an embodiment, the wash solution includes from 0.05 wt % to 5 wt %, or from 1 wt % to 5 wt %, or from 0.5 wt % to 3 wt %, or from 1 wt % to 2 wt % of the base, based on the total weight of the wash solution.

In an embodiment, the wash solution includes (i) water, (ii) 0 wt %, or from 0.05 wt % to 5 wt %, or from 0.1 wt % to 3 wt %, or from 0.5 wt % to 1.5 wt % of a surfactant including a non-ionic secondary alcohol ethoxylate, based on the total weight of the wash solution, and (iii) from 0.05 wt % to 5 wt %, or from 0.1 wt % to 5 wt %, or from 0.5 wt % to 3 wt %, or from 1 wt % to 2 wt % of a base that is sodium hydroxide, based on the total weight of the wash solution.

The process includes contacting the article with the wash solution under conditions sufficient to separate the first substrate from the second substrate (i.e., label facestock).

In an embodiment, the term “contact” or “contacting” refers to immersing the article in the wash solution. The term “under conditions sufficient to separate the first substrate from the second substrate” includes (i) introducing the batch into a mixing device and (ii) agitating the batch under conditions sufficient to separate the first substrate from the second substrate. The mixing device may mechanically agitate the batch, or otherwise the batch can be manually agitated with a stirring rod. Nonlimiting examples of suitable mixing devices include a flask, a beaker, a horizontal ribbon mixer, a paddle mixer, a tumbler mixer, a drum mixer, a static mixer, a planetary mixer, and a premixer. Any of the foregoing mixing devices may be equipped with a suitable equipment to mix, agitate, blend, spin, and/or stir the contents therein. The mixing device mixes the article with the wash solution and brings the adhesive layer into full contact with the wash solution.

The term “agitate” or “agitating” refers to a motion of mixing, blending, spinning, tumbling, shaking, and/or stirring the article in the wash solution.

The term “conditions sufficient to separate the first substrate from the second substrate” further includes the operation parameters under which the swelling and detachment of the adhesive layer is promoted. In an embodiment, the conditions include (i) the agitation speed of the mixture including the article and the wash solution (interchangeably referred to as the “batch”), (ii) the temperature of the wash solution, and (iii) the pH of the wash solution.

In an embodiment, the conditions sufficient to separate the first substrate from the second substrate includes one, some, or all of the following parameters:
(i) agitating the article immersed in the wash solution at a rate from 50 rpm to 1000 rpm, or from 100 rpm to 600 rpm, or from 100 rpm to 500 rpm; and/or
(ii) heating the wash solution to a temperature from 30° C. to 65° C., or from 30° C. to 55° C., or from 35° C. to 55° C., or from 35° C. to 45° C.; and/or
(iii) adjusting the pH of the wash solution from 7 to 14, or from 10 to 14.

Bounded by no particular theory, it is believed the wash solution swells the adhesive composition, such that some, or all, of the adhesive composition cleanly detaches from the first substrate and away from the first substrate. The term “separate” or “separating” refers to removing some, or all, of the adhesive layer (and concomitantly the second substrate) from the first substrate.

In an embodiment, the process further includes removing the first substrate (with little, or no, adhesive layer) from the wash solution and rinsing the first substrate with water before further recycling step. In this way, the label facestock and adhesive composition are removed from the first substrate.

In an embodiment, the process includes:
(1) providing a batch comprising an article and a wash solution, the article comprising
   A. a first substrate; and
   B. an adhesive layer in contact with the first substrate, the adhesive layer comprising an adhesive composition comprising
      (i) from 80 wt % to 99 wt %, or from 85 wt % to 99 wt %, or from 90 wt % to 99 wt %, or from 95 wt % to 99 wt %, based on the total weight of the adhesive composition, an acrylic polymer comprising polymerized units of
         (a) from 50 wt % to 90 wt %, from 60 wt % to 80 wt %, from 65 wt % to 75 wt %, or from 50 wt % to 71 wt %, based on the total weight of the acrylic polymer, a first monomer that is a C₄-C₁₈ alkyl acrylate; and
         (b) from 20 wt % to 50 wt %, from greater than 20 wt % to 40 wt %, or from 25 wt % to 40 wt %, based on the total weight of the acrylic polymer, of a second monomer selected from the group consisting of a C₁-C₃ alkyl acrylate optionally containing a hydroxyl group, acrylic acid, and methacrylic acid; and
         (c) from 0.5 wt % to 20 wt %, from 1 wt % to 10 wt %, or from 1 wt % to 5 wt %, based on the total weight of the acrylic polymer, of a third monomer that has a carboxylic acid functional group;
      (ii) from 0.05 wt % to 5 wt %, or from 0.5 wt % to 3 wt %, or from 0.5 wt % to 1 wt %, based on the total weight of the adhesive composition, of at least one inorganic neutralizer; and
      (iii) from 0.1 wt % to 5 wt %, or from 0.5 wt % to 3 wt %, or from 1 wt % to 3 wt %, based on the total weight of the adhesive composition, of at least one surfactant; and
   C. a second substrate in contact with the adhesive layer; and the wash solution comprising
      (i) water,
      (ii) 0 wt %, or from 0.05 wt % to 5 wt %, or from 0.1 wt % to 3 wt %, or from 0.5 wt % to 1 wt % of a surfactant, based on the total weight of the wash solution, and
      (iii) from 0.05 wt % to 5 wt %, or from 0.5 wt % to 3 wt %, or from 1 wt % to 2 wt % of a base, based on the total weight of the wash solution; and
(2) immersing the article in the wash solution;
(3) agitating the article and the wash solution under conditions sufficient to separate the first substrate from the second substrate; and
(4) removing the second substrate from the first substrate.

The process is effectuated in that dense first substrates like PET (PET bottle) will sink and light second substrates (such as label PP) will float such that the first substrate can be separated from the second substrate by a filtration process whereby the floating light second substrate (label facestock) and sediment dense first substrate (PET bottle) are separated from each other. (Strainers, filters or skimming method can be used). In an embodiment, the first substrate has a density from greater than 1 g/cm³ to less than 3 g/cm³, and nonlimiting examples include PET. Second substrate has a density from greater than 0.01 g/cm³ to less than 1 g/cm³ and floats on the surface of the wash solution.

In an embodiment, the first substrate is separated from the second substrate by sink and float mechanism. This sink and float mechanism takes the advantage of the difference in the density of the first substrate (bottle) and the label facestock (second substrate).

In an embodiment, the first substrate has a density less than 1 g/cm³. A nonlimiting example includes HDPE bottle which will float on the surface of the wash solution, and the second substrate has a density greater than 1 g/cm³ such as alkali resistant paper. In this situation, the first substrate (HDPE) will float while the second substrate (alkali resistant paper) will sink to the bottom of the wash solution.

In an embodiment, the first substrate is separated from the second substrate by sink and float mechanism. This sink and float mechanism takes the advantage of the difference in the density of the first substrate and the label system (second substrate). In some cases, paper label can be dispersed in small fibers which will float, or sink based on composition of the paper label and they will have to be filtered from the system.

In an embodiment, the second substrate is a paper label that disintegrates and disperses into the wash solution to smaller particles under conditions sufficient to separate the first substrate from the second substrate. In an embodiment, separating includes filtering the first substrate with strainer (mesh filter) from the wash solution.

By way of example, and not limitation, some embodiments of the present disclosure will now be described in detail in the following examples.

### EXAMPLES

### 1. Materials

The materials used in the inventive examples (“IE”) and comparative samples (“CS”) are provided in Table 1 below.

TABLE 1

| Material | Properties | Source |
|---|---|---|
| Substrate | Generic bottle or container made of PET resin | FONTER (agua con gas |
| (polyethylene terephthalate) | | 0.5 l from Mercadona |
| Coated sample 1 (Paper | 80 gsm MOSAICO paper | Burgo group |
| Facestock) | | |
| Liner | 58 gsm Glassen paper with 51 μm caliper and | UPM Kymmene |
| (Siliconized paper) | coated with 1 μm of silicon layer | |
| Coated Sample 2 | 48 μm one side treated transparent BOPP film | Manucore |
| (Biaxial oriented | with 43.7 gsm unit weight | |
| polypropylene film) | | |
| Hydrophilic primer | A self-crosslinking emulsion | Dow |
| (PRIMAL™ TR-407) | | |
| C₄-C₁₈ alkyl acrylate | Structure: | BASF |
| monomer (2-Ethylhexyl acrylate) | 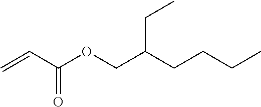 | |
| | Hydrophobic Monomer | |
| Monomer | Structure: | Dow Chemical |
| (Ethyl acrylate) | 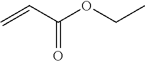 | |
| | Hydrophilic Monomer | |
| Monomer | Structure: | Dow Chemical |
| (Glacial Acrylic acid) | 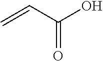 | |
| | Hydrophilic Acid Monomer | |
| Surfactant | Chemical: sodium dodecylbenzenesulfonate (branched) | Stepan |
| (Siponate DS-4) | Sodium salt of branched alkylbenzene sulfonic acid | |
| | C12H25 SO3Na Anionic Surfactant | |
| Surfactant | Chemical: disodium ethoxylated alcohol (C₁₀-C₁₂) half | Solvay |
| (Aerosol A-102) | ester of sulfosuccinic acid; | |
| | CAS No.: 68815-56-5; | |
| | Molecular formula: C₂₆H₄₈O₁₁Na₂S (average); | |
| | Molecular weight: 614 g/mol (average) | |
| | Anionic Surfactant | |
| Inorganic neutralizer/base | Chemical: NaOH | Fisher Scientific |
| (Sodium hydroxide) | Buffering Agent and Neutralizing Agent | |
| Surfactant | Chemical: sodium salts of C₁₂-C₁₄ alcohol ethersulfates | BASF |
| (Disponil Fes-77) | with ethoxylation, can be described by the formula below: | |
| | RO(CH₂CH₂O)ₓSO₃Na, with R = C₁₂-C₁₄ and x = 30 | |
| | Anionic Surfactant | |
| Surfactant | Chemical: sodium dioctyl sulfosuccinate in mixture of | Solvay |
| (Aerosol OT-75) | ethanol and water; | |
| | Molecular formula: C₂₀H₃₇O₇NaS | |
| | Molecular weight: 444 g/mol | |
| | Anionic Surfactant, Wetting Agent | |
| Surfactant | Chemical: ethoxylated 2,4,7,9-tetramethyl-5-d | Evonik |
| (Surfynol 440) | ecyne-4,7-diol; CAS No.: 9014-85-1 | |
| | Anionic Surfactant, Wetting Agent | |
| Surfactant | Chemical: secondary alcohol ethoxylate | Dow Chemical |
| (Tergitol 15-S-9) | CAS No.: 84133-50-6 | |

### A. Synthesis of the Acrylic Polymer in the Adhesive Composition in IE1 and IE2

A monomer emulsion containing 86.31 wt % monomer mixtures was prepared by mixing (i) a monomer composition containing 71 wt % of a first monomer 2-ethylhexyl acrylate, 26 wt % of a second monomer ethyl acrylate, and 3 wt % of a third monomer acrylic acid, based on the total weight of the first, the second, and the third monomers, (ii) sodium dodecylbenzenesulfonate (branched), (iii) Aerosol A-102, and (iv) a small amount of sodium hydroxide (monomer emulsion buffer). Wt % based on total weight of the polymer batch/emulsion.

With the reactor water held at 90-92° C., a solution of 0.054 wt % sodium carbonate total batch) and 0.312 wt % sodium persulfate) in water was added to the reactor.

0.22 wt % of a polymer latex (with diameter 250 nm seed) was added to the kettle and held two minutes before the addition of 0.13 wt % of second polymer latex (with diameter 100 nm seed).

With the reactor at ˜83° C., a gradual addition thermal polymerization was conducted by feeding the monomer emulsion along with a cofeed of sodium persulfate (0.23 wt %) to the reactor over 150 minutes, while maintaining a reactor temperature of 85-87° C.

After adding 60 wt % of the monomer emulsion feeds, 0.26 wt % polymer latex with diameter <50 nm seed was added to the reactor to create a third smaller particle size polymer mode.

While at ˜84° C., a chase redox pair of 0.16 wt % tert-butyl hydroperoxide and 0.064 wt % of D(−)-isoascorbic acid cofeed reagents were fed into the reactor over 45 minutes to reduce the residual monomer levels to final specifications.

At a temperature of 55° C. or less, the reaction was adjusted to a pH from 4 to 4.5 by ammonium hydroxide to produce the acrylic polymer containing 71 wt % 2-EHA, 26 wt % EA, and 3 wt % AA, based on the total weight of the acrylic polymer.

A post-add solution containing 0.26 wt % Surfynol 440, 1.21 wt % Disponil Fes 77, and 0.42 wt % Aerosol OT-75 (weight percent based on total weight of adhesive composition) was added to the acrylic polymer in the kettle over 30 minutes while cooling to 40-45° C.

At a temperature of less than 45° C., the inorganic neutralizer (10 wt % aqueous sodium hydroxide) was added until a latex pH of 8-8.5 was reached. Fifteen minutes later, a biocide package was added and the final solids was from 57.5 to 58.5%.

The obtained adhesive composition was filtered through a 100-mesh bag and packed out.

### C. Preparation of the Label

Coated Sample 1 (paper label) and Coated Sample 2 (filmic label) were coated (with the present inventive adhesive composition and evaluated for adhesive washing performance, adhesion level, tack and shear properties. The procedure for preparing each sample is provided below.

### Coated Sample 1 (Paper Label Assembly)

One side of the 80 gsm MOSAICO paper was directly coated with the hydrophilic primer PRIMAL™ TR-407 and dried for three minutes in 70° C. to obtain a final primer coat weight of 2 gsm, to prepare the paper facestock. The adhesive dispersion was prepared (formulated), conditioned 24 hours before application and then coated directly on the pre-siliconized paper liner. The wet adhesive coated pre-siliconized paper liner was then dried for 2 min at 105° C. to obtain a 18 gsm of the dry innovative adhesive layer, to prepare the adhesive layer. The PRIMAL™ TR-407 coated paper was laminated to the dry adhesive layer at 40° C./40 psi.

### Coated Sample 2 (Filmic Label Assembly)

One side of oriented polypropylene film (OPP) was coated with the hydrophilic primer PRIMAL™ TR-407 at a coat weight of 2 gsm, followed by drying for three minutes at 70° C., to prepare the filmic facestock. The adhesive dispersion was prepared (formulated), conditioned 24 hours before application and then coated directly on the pre-siliconized paper liner. The wet adhesive coated pre-siliconized paper liner was then dried for 2 min at 105° C. to obtain a 18 gsm of the dry innovative adhesive layer, to prepare the adhesive layer. Then the PRIMAL™ TR-407 coated paper side was laminated with dry adhesive layer under lamination conditions of 40° C./40 psi. The results for the adhesion, loop tack, and shear resistance tests on Coated Samples 1 and 2 are shown in Table 2 below.

TABLE 2

| Tests from glass plates | Coated Sample 1(IE 1) | Coated Sample 2 (CS1) |
|---|---|---|
| 90° Peel Adhesion 20 min dwell time (N/inch) | 4.7 (“A”)* | 5.5 (“A”) |
| 90° Peel Adhesion 24 hrs dwell time(N/inch) | 7.2 (“PT”)* | 7.2 (“A”) |
| Loop Tack (N/inch²) | 9.3 (“A”) | 8.3 (“A”) |
| Shear Resistance (hours) | >20 | >20 |

*“A” indicates “Adhesion Failure”
*“PT” indicates “Paper Tear”

The measured data depicts that the PSA properties of the present article and/or present adhesive composition shown in Table 2 are within acceptable performance range to non-washable adhesive requirements on the market. The present adhesive composition exhibits similar or better performance during the use but with the additional benefit of being removable (or washed off) under the conditions mentioned previously, allowing the substrate to which it was attached, to be recycled.

### D. Preparation of IE1 (PET/Adhesive/Mospaper)

The previously prepared paper label (Coated sample 1) with 80 gsm MOSAICO paper was hand applied on to the PET bottle side wall using a light pressure from the thumb to eliminate air bubbles. This labeled PET bottle was then stored for 4 days in CTR before testing for cutting it in small flakes (1×1 cm) for performing the wash test. The label size is approximately 6 cm wide and 10 cm long strip.

### E. Preparation of Comparative CS1 (PET/Adhesive/BOPP)

The previously prepared oriented polypropylene film (OPP) label (Coated sample 2) with 48 μm thick (43.7 gsm unit weight) oriented polypropylene film was hand applied on to the PET bottle side wall using a light pressure from the thumb to eliminate air bubbles. This labeled PET bottle was then stored for 4 days in CTR before testing for cutting it in small flakes (1×1 cm) for performing the wash test. The label size is approximately 6 cm wide and 10 cm long strip.

### F. Wash Procedure and the Results

The wash procedure was conducted with 20 mL wash solution containing 1 wt % of NaOH and 0.5 wt % Tergitol™ 15-S-9 in water. After the wash solution was prepared and added to a beaker, the temperature of the wash solution was raised to the corresponding temperature to be tested (i.e. 35° C., 45° C., or 55° C.) and maintained at that temperature until the wash ended.

Twenty 1 cm×1 cm flakes of IE1 were added to the beaker and immersed in the heated wash solution. The beaker was equipped with a 4 cm magnetic stirrer to impart a mixing speed of 350 rpm and agitate the flakes in the wash solution. The time that it took for complete detachment of paper label (Coated sample 1) from the PET substrate was recorded and shown in Table 3.

TABLE 3

| | Coated Sample 1(IE 1) | | Coated Sample 1(IE 1) | | Coated Sample 1(IE 1) | |
|---|---|---|---|---|---|---|
| Temperature of the wash | 35° | C. | 45° | C. | 55° | C. |
| solution | | | | | | |
| Percentage of flakes that have | 100% | | 100% | | 100% | |
| the paper label washed off at the | | | | | | |
| end of wash | | | | | | |
| Wash-off time | <5 | minutes | <5 | minutes | <5 | minutes |

As shown in Table 3, the paper substrate completely detaches from the PET substrate at a wash solution temperature ranging from 35° C. to 55° C. within 5 minutes.

It is specifically intended that the present disclosure not be limited to the embodiments and illustrations contained herein, but include modified forms of those embodiments including portions of the embodiments and combinations of elements of different embodiments as come within the scope of the following claims.

1. An article comprising:
A. a first substrate; and
B. an adhesive layer in contact with the first substrate, the adhesive layer comprising an adhesive composition comprising
(i) an acrylic polymer comprising polymerized units of
(a) a first monomer that is a C₄-C₁₈ alkyl acrylate; and
(b) a second monomer selected from the group consisting of acrylic acid, methacrylic acid, and a C₁-C₃ alkyl acrylate optionally containing a hydroxyl group;
(ii) at least one inorganic neutralizer; and
(iii) at least one surfactant; and
C. a second substrate in contact with the adhesive layer.

2. The article of claim 1 comprising (D) a primer layer located between the adhesive layer and the second substrate.

3. The article of claim 1, wherein the C₄-C₁₈ alkyl acrylate is selected from the group consisting of butyl acrylate, butyl methacrylate, ethylhexyl acrylate, octyl acrylate, isooctyl methacrylate, decyl methacrylate, isodecyl methacrylate, lauryl methacrylate, pentadecyl methacrylate, and stearyl methacrylate.

4. The article of claim 1, wherein the C₁-C₃ alkyl acrylate optionally containing a hydroxyl group is selected from the group consisting of methyl acrylate, ethyl acrylate, propyl acrylate, hydroxyethyl acrylate, hydroxyethyl methacrylate, hydroxypropyl acrylate, and hydroxypropyl methacrylate.

5. The article of claim 1, wherein the acrylic polymer is a 2-ethylhexyl acrylate/ethyl acrylate/acrylic acid terpolymer.

6. The article of claim 1, wherein the terpolymer comprises, based on the total weight of the terpolymer
(i) from 50 wt % to 71 wt % of ethylhexyl acrylate;
(ii) from 25 wt % to 40 wt % of ethyl acrylate; and
(iii) from 1 wt % to 10 wt % of acrylic acid.

7. The article of claim 1, wherein the at least one inorganic neutralizer is sodium hydroxide.

8. The article of claim 1, wherein the at least one surfactant comprises a fatty alcohol ether sulfate.

9. The article of claim 1, wherein the adhesive composition comprises, based on the total weight of the adhesive composition
from 80 wt % to 99 wt % of the acrylic polymer;
from 0.05 wt % to 5 wt % of the at least one inorganic neutralizer; and
from 0.1 wt % to 5 wt % of the at least one surfactant.

10. The article of claim 1, wherein the first substrate is selected from the group consisting of a plastic container and a plastic film and the second substrate is a label.

11. A process comprising:
(1) providing a batch comprising an article and a wash solution,
the article comprising
A. a first substrate; and
B. an adhesive layer in contact with the first substrate, the adhesive layer comprising an adhesive composition comprising
(i) an acrylic polymer comprising polymerized units of
(a) a first monomer that is a C₄-C₁₈ alkyl acrylate; and
(b) a second monomer selected from the group consisting of acrylic acid, methacrylic acid, and a C₁-C₃ alkyl acrylate optionally containing a hydroxyl group;
(ii) at least one inorganic neutralizer; and
(iii) at least one surfactant; and
C. a second substrate in contact with the adhesive layer; and
the wash solution comprising water, a surfactant, and a base;
(2) contacting the article with the wash solution under conditions sufficient to separate the second substrate from the first substrate.

12. The process of claim 11, wherein the contacting step comprises immersing the article in the wash solution and agitating the article and the wash solution in temperature below 65° C.

13. The process of claim 11, wherein the base is sodium hydroxide.

14. The process of claim 11, wherein the surfactant comprises a non-ionic secondary alcohol ethoxylate.

15. The process of claim 11, wherein the wash solution has from 0.1 wt % to 5 wt % of the base, based on the total weight of the wash solution.
